(19) United States
(12) Patent Application Publication
(10) Pub. No.: US 2010/0133128 A1
(43) Pub. Date: Jun. 3, 2010

(54) GIFT CARD BOOK STYLE O-SLEEVE

(75) Inventor: Mark Preece, Valencia, CA (US)

Correspondence Address: MEADWESTVACO CORPORATION;ATTN: IP LEGAL DEPARTMENT, 1021 MAIN CAMPUS DRIVE, RALEIGH, NC, 27606, US

(73) Assignee: MeadWestvaco Corporation, Glen Allen, VA (US)

(21) Appl. No.: 12/624,476

(22) Filed: Nov. 24, 2009

Related U.S. Application Data
(60) Provisional application No. 61/119,573, filed on Dec. 3, 2008.

(51) Int. Cl. B65D 71/00; B31B 1/00

(52) U.S. Cl. 206/232; 493/267

(57) ABSTRACT

A method is disclosed for housing a gift card within a package whereby the gift card is completely concealed within the package, a printed code related to the gift card is printed on an external surface of the package, and the gift card may be activated without opening the package. A packaging structure is also disclosed for use with the method.

### REFERENCE TO RELATED APPLICATION

This application claims the benefit of priority under 34 U.S.C. 119(e) of U.S. provisional application Ser. No. 61/119,573, filed on Dec. 3, 2008, which is hereby incorporated by reference in its entirety.

### BACKGROUND OF THE INVENTION

The present invention relates generally to a package containing a gift card and, more particularly, to a package with a concealed gift card that can be scanned and activated at retail without removing the card from the packaging.

Various types of items may be packaged with the package. For example, a media disc, an electronic module or game, or a memory card, are among the items that may be held within the package. It may be useful to contain or conceal within the package a gift card, for example as an incentive to return to the same retailer, or to provide the recipient of the package with funds by which to purchase related equipment, or download additional software through the internet.

As used herein, the terms media disc, compact disc, CD or disc are intended to encompass all such discs, whatever their size, for all known or proposed uses.

In order to deter theft, gift cards may be packaged and displayed having no real value until they are “activated”, that is, until a validating transaction is completed, typically at a point-of-sale such as a checkout lane, whereby the card is activated by an authorized party. Typically this activation may be accomplished at the cash register when payment is made. Each gift card may have a unique identifier to help with this validating transaction. Usually this identifier is printed on the card or stored on a magnetic or electronic memory on the card. If the gift card is contained or concealed within a package, some access may be required in order to determine the identifier. For example, an identifier printed on the card may be made visible by providing a window or cutout in the package. Alternately a magnetic or electronic identifier might be read by a contact or proximity reader able to read through a layer of paper or paperboard. However, in many instances, data acquisition by a point of sale terminal may be limited to an optical barcode scanner. In such instances a gift card concealed within a package may not be accessible for validation unless the package is first opened.

There remains a need for a simple, attractive, and inexpensive package that may contain a concealed gift card and yet allow the gift card to be activated without opening the package.

### SUMMARY OF THE INVENTION

The present disclosure is directed to a package for housing a concealed gift card while providing a method for activating the gift card without opening the package. Variations of the illustrative embodiments are also within the contemplation of the present disclosure, including variations in the size, shape, material, and the nature of any content items within the package in addition to the gift card.

It should be appreciated that the present invention can be implemented and utilized in numerous ways, including without limitation as a process, an apparatus, a system, a device, and a method for applications and from other suitable materials now known and later developed. These and other unique features of the system disclosed herein will become more readily apparent from the following description and the accompanying drawings.

### BRIEF DESCRIPTION OF THE DRAWINGS

So that those having ordinary skill in the art to which the disclosed system appertains will more readily understand how to make and use the same, reference may be had to the following drawings.

FIG. 1 shows a perspective view of a blank for making a package;

FIG. 2 shows an isometric front view of an assembled package made from the blank of FIG. 1;

FIG. 3 shows an isometric back view of the assembled package;

FIG. 4 shows a perspective view of the inside of the assembled package;

FIG. 5 shows a step in opening an access panel to gain access to a gift card with in the package;

FIG. 6 shows a further step in opening the access panel;

FIG. 7 shows a finished step in removing the gift card from the package; and

FIG. 8 shows the exterior of the package, with the removed gift card placed upon it.

### DESCRIPTION OF EXEMPLARY EMBODIMENTS

The present disclosure is for a book-like or sleeve-like package for optical media or other items. The advantages, and other features of the package disclosed herein, will become more readily apparent to those having ordinary skill in the art from the following detailed description of certain exemplary embodiments taken in conjunction with the drawings which set forth representative embodiments of the present invention and wherein like reference numerals identify similar structural elements whenever possible.

All relative descriptions herein such as left, right, up, down, topside, underside and the like are with reference to the Figures, and not meant in a limiting sense. The illustrated embodiments can be understood as providing exemplary features of varying detail of certain embodiments, and therefore, unless otherwise specified, features, components, modules, elements, and/or aspects of the illustrations can be otherwise combined, interconnected, sequenced, separated, interchanged, positioned, and/or rearranged without materially departing from the disclosed systems or methods. Additionally, the shapes and sizes of components are also exemplary and unless otherwise specified, can be altered without materially affecting or limiting the disclosed technology to holding discs exclusively.

The invention provides a method of concealing a gift card within a package that may be scanned and activated at a retail location without removing the gift card from the package. The package may be pre-loaded with the card before it goes to a processing step such as being loaded with an optical media at a replicator.

In an exemplary embodiment the package may be of a book or sleeve style, optionally with a closure (such as a Velcro dot) and may have a perforated or otherwise defined panel on the inside of the book flap. The perforated panel may be removed by the end consumer to access the gift card. The gift card in this embodiment may be concealed within the package, with no ready access for reading its activation code (which may be a barcode). Thus it may be advantageous to have a method to capture the activation code at retail without removing the gift card.

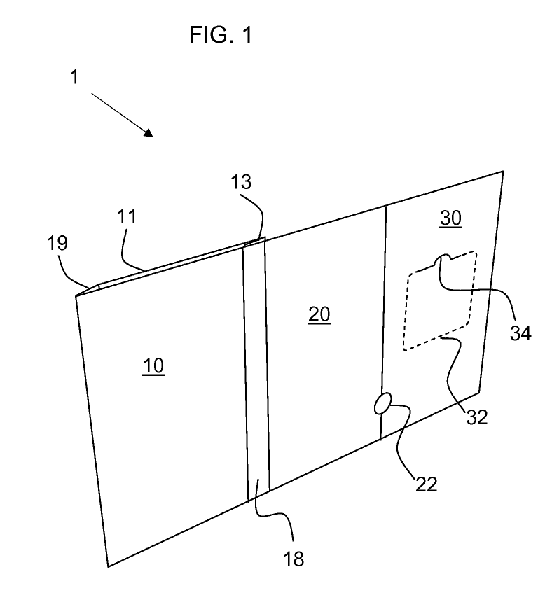

Exemplary embodiments of the present invention are illustrated in FIGS. 1-8, in which there is shown a media package. In brief overview, the packages are made from folded sheet or sheets of a material such as paperboard having, for example, a thickness of approximately 0.036 inches.

FIG. 1 shows certain a package blank 1 prior to assembly. This example shows an “O-Sleeve”, that can be folded into a tubular “sleeve” to receive an item such as a DVD case. The package blank may comprise back panel 10, which may be attached by a fold line to end panel 19, thence by fold line to front panel 11, and thence by fold line to glue flap 13. Glue flap 13 may be glued to the inside of spine panel 18, thus forming a tubular sleeve (panels 10, 19, 11, 18). Furthermore, the package may be provided with a flap formed for example by inner flap panel 30 and outer flap panel 20. Outer flap panel 20 as shown in FIG. 1 may be attached by fold line to spine 18, which in turn may be attached by fold line to back panel 10.

Along the fold line between outer flap panel 20 and inner flap panel 30 may be an aperture 22, such as a circular cutout. On the inner flap panel 30 may be provided perforations 32 and cut lines 34 generally defining a removable door whose use will be described in the following figures.

It is often advantageous to ship partially completed packages in a flattened configuration, such as is generally shown in FIG. 1, where the O-Sleeve is in an essentially flattened state as it would be prior to bending the fold lines adjacent spine panel 18 and end panel 19.

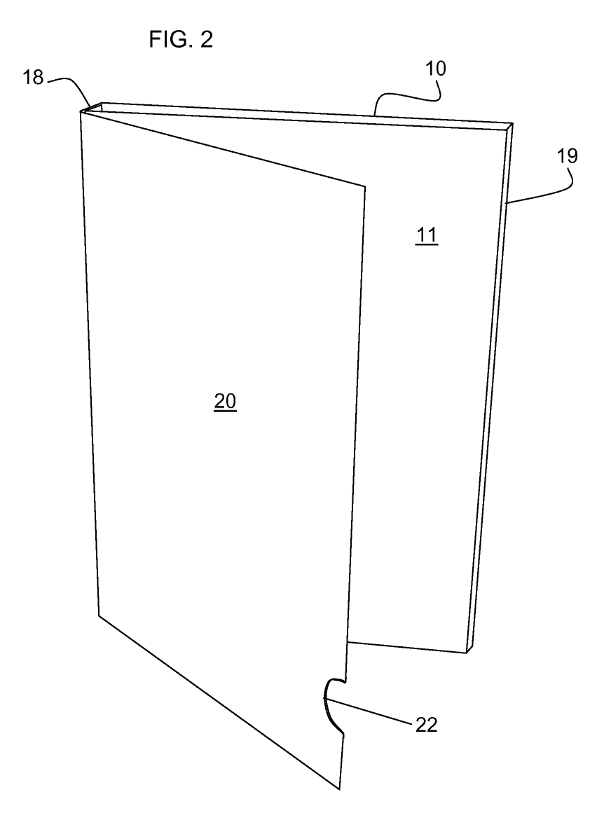

FIG. 2 shows a front view of a package made by further folding the blank of FIG. 1. The inner flap panel 30 (no longer seen) having been folded inward with respect to the outer flap panel 20, aperture 22 may form a semicircular cutout along the edge of the flap. An item, such as an injection molded or otherwise formed DVD case (not shown) may be inserted into the sleeve generally formed by back panel 10, front panel 11, spine 18 and end panel 19.

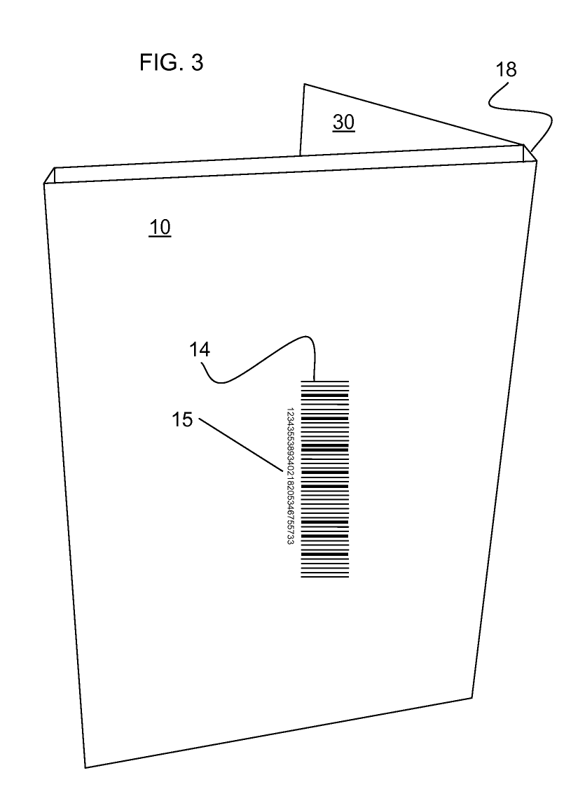

FIG. 3 shows a back view of the package. The back panel 10 may have printed thereon one or more barcode 14, which optionally may have an associated printed number 15. Barcode 14 and associated number 15 may be printed anywhere on the exterior of the package, for example on the back panel 10 as shown, or on the outer flap panel 20, or both. Although barcode 14 and associated number 15 are shown approximately centered on back panel 10, they may also be provided along the periphery of back panel 10.

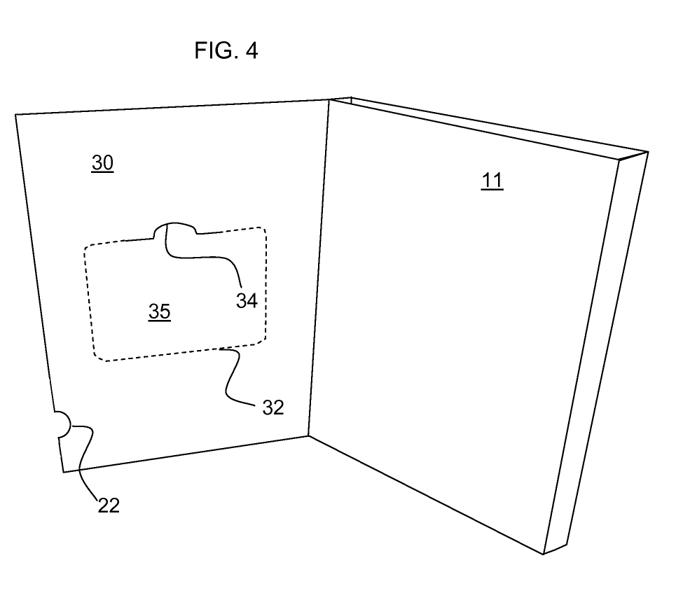

FIG. 4 shows another view of the package, with the flap opened outward as denoted by the separation between front panel 11 and inner flap panel 30. The inner flap panel 30 may have provided thereon perforations 32 (or score lines or partially cut lines) generally defining a door 35 in inner flap panel 30. To facilitate opening the door, a cut line 34 or cut lines may define a tab or other feature adapted to be easily grasped may be cut in the door.

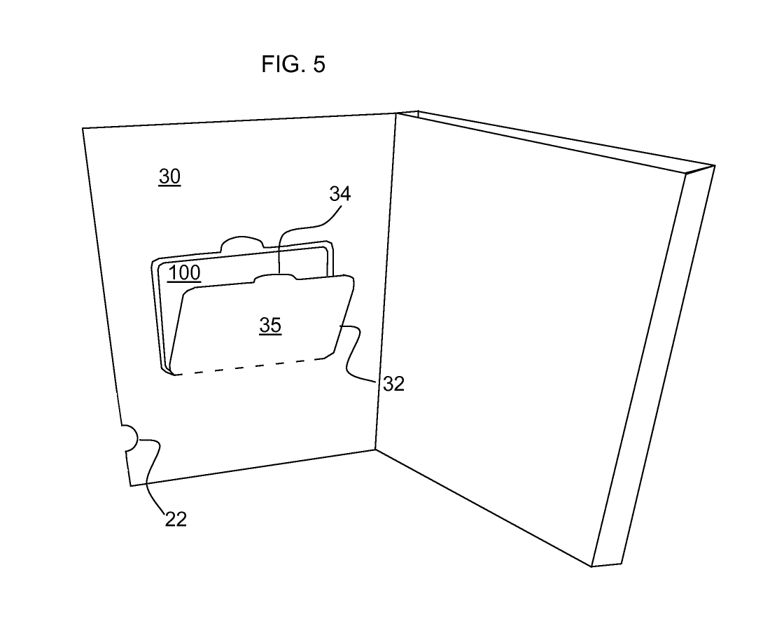

FIG. 5 shows a step in removing door 35, for example by grasping and pulling tab defined by cut lines 34, causing tearing along perforations 32. Behind door 35 may be concealed a gift card 100.

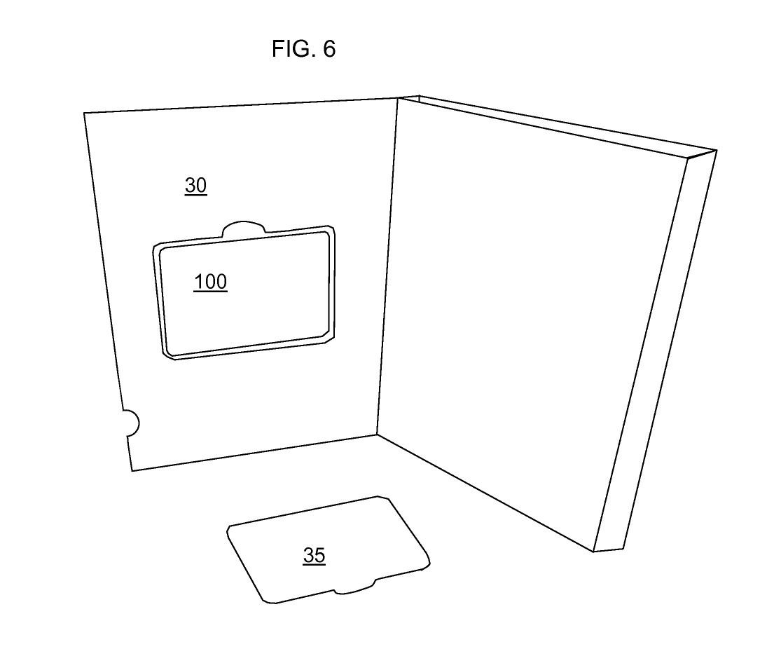

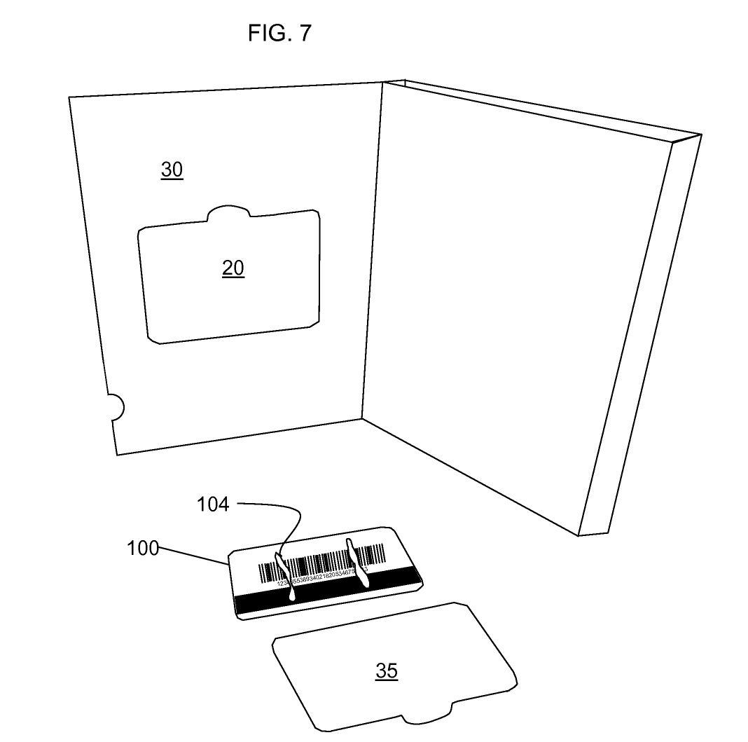

FIG. 6 shows a further step wherein door 35 may be detached from inner flap panel 30. This may, as shown, completely exposed gift card 100, which may then be removed. FIG. 7 shows that an adhesive 104, such as tacky glue, may be used on gift card 100 to removably adhere the gift card to the package, for example, to the inner surface of outer flap panel 20. Alternately (not shown) the gift card may be adhered to the inside of door 35.

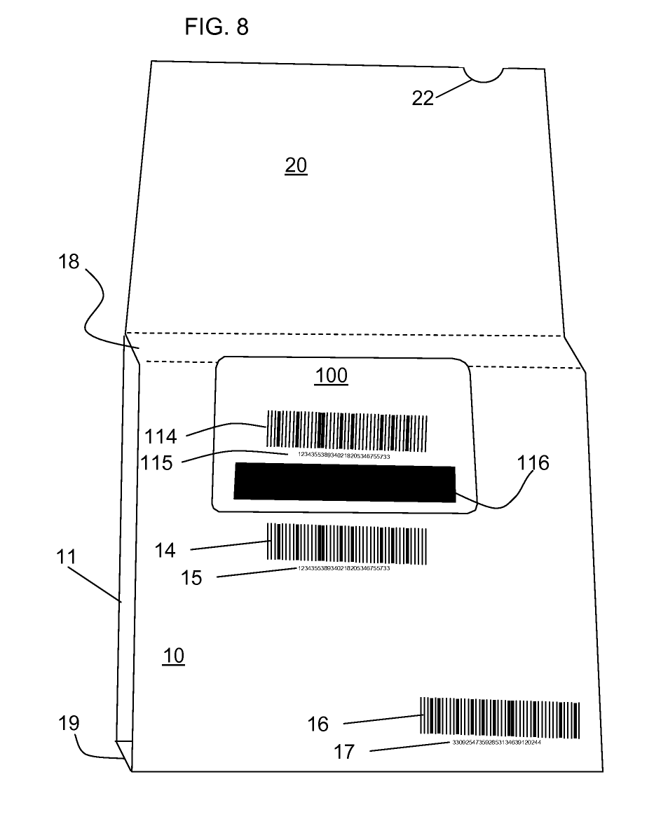

FIG. 8 shows gift card 100 placed upon the back panel 10 of the package for the purpose of illustrating an example how the gift card code may relate to a code on the outside of the package. Gift card 100 may have a barcode 114 and an optional associated number 115. The gift card may also have a magnetic stripe 116. In one embodiment, barcode 114 and barcode 14 may be identical. Associated number 115 and associated number 15 may be identical. Additional barcodes 16 and/or numbers 17 may be provided upon back panel 10 or outer flap panel 20, or spine 18 or end panel 19. For example, such barcodes or numbers may be associated with contents of the package other than the gift card. For example such other barcode 16 and/or number 17 may identify or be associated with a particular DVD product within the package, while barcode 14 and number 15 may identify or be associated with gift card 100.

Because the gift card barcode 114 and number 115 are also printed on the outside of the package as barcode 14 and number 15, it is not necessary to remove the gift card from the package in order to activate it. Instead, barcode 14 may be scanned at the point of purchase, and the gift card thereby activated.

One exemplary method of practicing the invention is to provide a package blank 1 and a gift card 100 to an assembly process. The barcode 114 and/or associated number 115 may be read, preferably by an automated process, and the same (or uniquely related) barcode 14 and/or associated number 15 printed onto the back panel 10 (either in the form of a blank or a partly assembled package. Gift card 100 may then be placed upon blank 1 or within the resulting package, optionally attached thereto by glue or adhesive. The outer flap panel 20 may be folded upon the gift card 100 and adhered or glued to the inner flap panel 30, thus securely trapping gift card 100. At this point, the partially finished blank, may be shipped elsewhere (or processed locally) for loading with product, for example loading an item into the O-Sleeve.

The package may contain items other than media discs. Although in some embodiments the packages may be made from paperboard having a thickness of about 0.036″, other types and thicknesses of materials may be utilized as are known in the packaging arts. The package may have a form other than an O-Sleeve, for example any type of structure suitable for housing an item or items.

The door 35 may be rectangular as shown in the Figures, or it may have other shapes that are suitable to accommodate a gift card.

Other than using a door to hold or conceal the gift card, the gift card may be held in a slit in the package structure, or may simply be adhered to an internal surface of the package, for example by tacky glue. Alternately the gift card may simply be placed loose within the package

Instead of the gift card being invisible from outside the closed package, there may be provided an opening in the package through which a portion of the card may be seen. For example, a corner of the card, or a portion showing a company logo, bank logo, or brand symbol (such as VISA, MASTERCARD, etc) may be visible through an opening in the package. This may help advertise the fact that a gift card is enclosed.

As noted above, the package can be formed using a variety of materials or substrates. For example, PRINTKOTE EAGLE®, which is composed of at least 10% post consumer recycled material, can be used. Moreover, a polymeric substrate such as calendered POLYLITH® GC-3 can be used. POLYLITH® substrate is manufactured by Nanya Plastics of Taiwan and is distributed in the U.S. by Granwell Products, Inc. POLYLITH® substrate is primarily formed using polypropylene resin and minerals comprising inert calcium carbonate and titanium dioxide and the resulting substrate is strengthened by calendaring.

While the invention has been described with respect to exemplary embodiments, those skilled in the art will readily appreciate that various changes and/or modifications can be made to the invention without departing from the spirit or scope of the invention.

What is claimed is:

1. A method for packaging a gift card, comprising:
reading a first code from the gift card;
placing the gift card within a package so that no part of the gift card is visible outside the finished package; and
printing a second code on the outside of the finished package;
wherein the second code is related to the first code.

2. The method of claim 1, wherein the first and second codes are both barcodes.

3. The method of claim 1, wherein the first and second codes are identical.

4. The method of claim 1, comprising a further step of reading the second code and using it to activate the gift card, without first opening the package.

5. A packaging structure, comprising:
a package for holding an item and a gift card;
wherein at least a part of the gift card is not visible from outside the package when the package is in an unopened configuration,
the gift card having an associated first code;
a second code printed on the outside of the package;
wherein the second code is related to the first code.

6. The packaging structure of claim 5, wherein the package is formed from paper or paperboard.

7. The packaging structure of claim 5, wherein the package comprises an O-sleeve.

8. The packaging structure of claim 6, wherein the gift card is placed between two layers of paper or paperboard, the two layers being at least partly adhered together.

9. The packaging structure of claim 8, wherein cut or perforated lines defining a tear-away door are provided in one of the two layers of paper or paperboard, and wherein removing the tear-away door reveals the gift card.

10. The packaging structure of claim 5, wherein no part of the gift card is visible from outside the package when the package is in an unopened configuration.

11. The packaging structure of claim 5, wherein a portion of the gift card is visible from outside the package when the package is in an unopened configuration.

12. The packaging structure of claim 5, wherein at least one of the first code and second code is a gift card activation code.

13. A method for packaging a gift card, comprising:
determining a first code associated with the gift card;
placing the gift card within a package so that at least part of the gift card is not visible outside the finished, unopened package; and
printing a second code on the outside of the package;
wherein the second code is related to the first code.

14. The method of claim 13, where no part of the gift card is visible from outside the unopened package.

15. The method of claim 13, where a portion of the gift card is visible from outside the unopened package.

16. The method of claim 13, wherein at least one of the first code and the second code is an activation code for the gift card.

17. The method of claim 13, comprising a further step of reading the second code and using it to activate the gift card, without first opening the package.

18. The method of claim 13, wherein at least one of the first and second codes is a barcode.

19. The method of claim 13, wherein the first and second codes are both barcodes.

20. The method of claim 13, wherein the first and second codes are identical.
